(19) United States
(12) Patent Application Publication
(10) Pub. No.: US 2006/0087828 A1
(43) Pub. Date: Apr. 27, 2006

(54) Light-emitting diode lamp with high heat dissipation

(76) Inventors: Ming-Der Lin, Hsin Chu (TW); San-Bao Lin, Chuang Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/972,350

(22) Filed: Oct. 26, 2004

(51) Int. Cl. F21V 9/16; F21V 29/00; F21V 13/12

(52) U.S. Cl. 362/84; 362/294; 362/245; 362/612; 362/613

(57) ABSTRACT

The invention discloses a light-emitting diode lamp with high heat dissipation that uses the high heat conductible material to make the lamp cavity and coordinates with the design of directly adhering base of the flip-chip light-emitting diodes and the cavity to achieve the purpose of guiding light and dissipating heat. The flip-chip light-emitting diode is used and arranged in matrix, the brightness and the uniformity can be effectively improved. The present invention can be applied to be the light source of the liquid crystal display, the advertisement board, the scanner and so on.

### BACKGROUND OF INVENTION

1. Field of the Invention

The present invention relates to a light-emitting diode lamp, and more particularly, to a light-emitting diode lamp with high heat dissipation.

2. Description of the Prior Art

The back light module, or named back light, is popularly applied to provide light source for the liquid crystal, such as the liquid crystal display, the cell phone panel, the advertisement board and so on. The liquid crystal material has good molecule alignment and mobile characteristic, and when irritated by the light, heat, electric field or magnetic field, the molecule alignment will be easily changed to allow the light passing through and form a gray-level contrast or other electric optical effect. But the liquid crystal material is not a self-emitting material, and an external light source is needed to display. Therefore, the light-guide module with back light or front light is provided as the external light source of the liquid crystal.

Generally, the light source of the light-guide module with back light or front light is cold cathode fluorescent lamp (CCFL), but the request for high voltage and alternating current power source of CCFL is an inconvenient disadvantage for the portable liquid crystal display. Subsequently, the lamp, or called light-guide tube, utilizing the light-emitting diodes as light source is developed. The light-emitting diodes are installed on one or both sides of the lamp and can luminesce in coordination with the light-guide design in the lamp. The light-emitting diode is generally a surface mount device light-emitting diode (SMD-LED) or a lamp light-emitting diode (Lamp-LED), and has the advantages of smaller volume, longer lifetime, and lighter weight and without the alternating current power source.

However, the lamp using the SMD-LED and the Lamp-LED as the light source still has some disadvantages. Firstly, for enhancing the brightness, the amount of the light-emitting diodes is always increased. But the entire lamp space is limited, and the brightness is restrictedly improved with the restrictedly increased light-emitting diodes. Secondly, regarding to the efficiency of heat dissipation, although the brightness can be also improved by raising the driving current of the light-emitting diode or using high-brightness light-emitting diode, the extra thermal energy will obstruct the efficiency of heat dissipation. Thirdly, regarding to the uniformity of the light, the SMD-LED and the Lamp-LED need larger space in the lamp, so the light has a worse uniformity.

In addition, illustrating with the Lamp-LED, the heat resistance is about 200° C./W, and that means 200° C. is produced when inputting 1 W. Under this high temperature, the epoxy resin will degrade, and the reliability is influenced and the input power is limited. Hence, how to lower the heat resistance and enhance the heat dissipation is an important target, especially to the product with high input power.

For solving the above-mentioned disadvantages, the present invention provides a light-emitting diode lamp with high heat dissipation. The light-emitting diode lamp has a better heat dissipation with using material of high heat conductivity as the lamp cavity. The light-emitting diode lamp further uses the flip-chip light-emitting diodes arranged in matrix as the light source, and can greatly improve the electric input power and increase the light output power. No matter increase amount of the light-emitting diode or raising the input current, the present invention can provide a better light uniformity.

### SUMMARY OF INVENTION

The purpose of present invention provides a lamp with high heat dissipation that uses the high heat conductible cavity to provide better heat dissipation.

Further, the purpose of present invention provides a lamp with high brightness and uniformity that uses the flip chip light-emitting diodes arranged in matrix to overcome the limitation of the arrangement space and improve the brightness and the uniformity.

Furthermore, the purpose of present invention provides a high efficiency lamp that utilizes high heat conductible cavity and the flip-chip light-emitting diodes arranged in high-density matrix to accomplish the great uniformity without requiring the precise optical system.

Furthermore, the purpose of present invention provides a lamp with high heat dissipation that utilizes the flip-chip light-emitting diodes arranged in matrix and the submount directly mounted on the lamp cavity to achieve the great heat dissipation.

Furthermore, the purpose of present invention provides a lamp with high heat dissipation that raises the input electric power to enhance the output optical power.

Furthermore, the purpose of present invention provides a lamp with high heat dissipation and high safety that using isolative and high heat conductive base and cavity to dissipate heat, and the electric power is supplied from top of the base and is isolated from the cavity that preventing electric leakage.

The present invention discloses a high heat conductible cavity on which equipped a rectangular opening and a transparent cover, and flip chip light-emitting diodes arranged in matrix for providing the light source. The entire design has not only good heat dissipation but also high brightness uniformly luminescing through the transparent cover.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a structural graph of a preferred embodiment according to the present invention.

FIG. 2 is an exploded structural graph of a preferred embodiment according to the present invention.

FIG. 3 is a structural side view of a preferred embodiment according to the present invention.

FIG. 4 is a structural graph of a light-emitting diode according to the present invention.

FIG. 5 is a structural graph of another embodiment according to the present invention.

FIGS. 6(a) and 6(b) are schematic graphs of power conduction designs on the base of the flip-chip light-emitting diode according to the present invention.

FIG. 6(c) is a structural graph enlarged the bakelite and the copper pillar in FIG. 6(b).

10 light-emitting diode lamp

12 heat conductible cavity

14 transparent cover

16 light-emitting diode
160 flip-chip light-emitting diode
162 light-emitting diode chip
164 base

18 rectangular opening

20 reflective pattern

22 chamber

24 fluorescent powder

26 epoxy resin

28 power line

30 cavity hole

32 bakelite

34 copper pillar

### DETAILED DESCRIPTION

The present invention is a light-emitting diode lamp with high heat dissipation that is used to improve the disadvantages of brightness and heat dissipation of the conventional lamp.

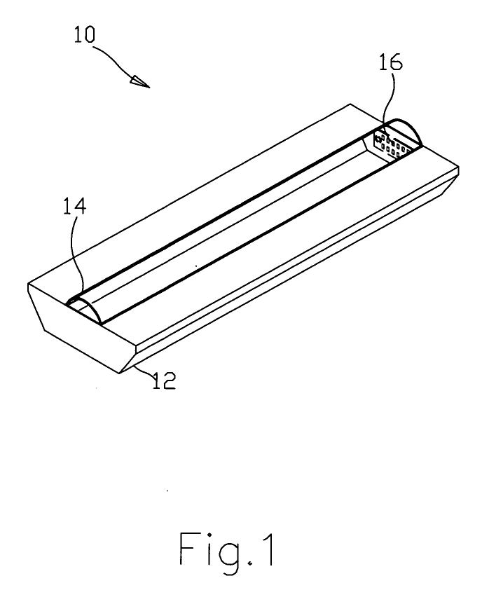

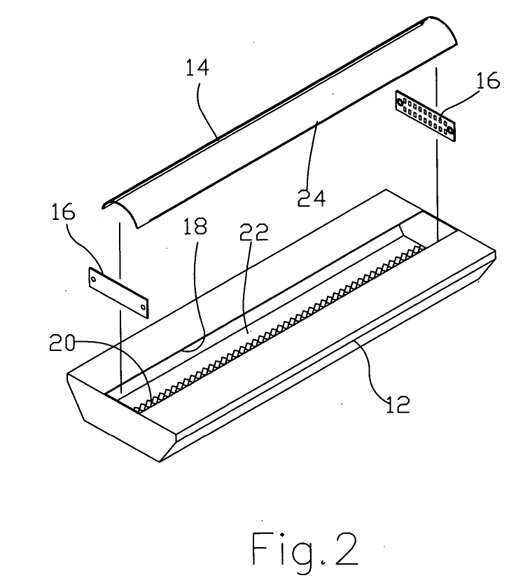

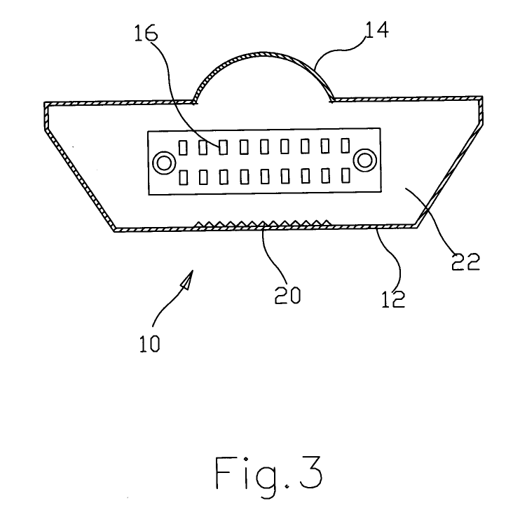

Please refer to FIGS. 1 and 2, which are a structural diagram and an exploded structural diagram of a preferred embodiment according to the present invention. As shown in figures, a light-emitting diode lamp 10 with high heat dissipation comprises a heat conductible cavity 12, a transparent cover 14 and a plurality of light-emitting diodes 16. The heat conductible cavity 12 is made by material with high heat conductivity, such as metal or ceramics. Since material of the heat conductible cavity 12 has better heat conductivity, the entire lamp 10 will also have better heat dissipation. When choosing material of the heat conductible cavity 12 among all kinds of metals, aluminum is the preferred one as its low cost and high heat conductivity. A rectangular opening 18 is further formed on the heat conductible cavity 12 for the light passing, and a reflective pattern 20 is formed under the cavity 12 corresponding to the opening 18 to reflect and uniform the light. The reflective pattern 20, such as circular dot pattern, rectangular fillister pattern, slanting V-shaped continuous fillister pattern, V-shaped continuous fillister pattern and V-shaped intermittent fillister pattern, can enhance the refraction and uniform the light. The transparent cover 14 is equipped on the rectangular opening 18 to form a chamber 22 with the heat conductible cavity 12. The transparent cover 14 such as a condensing lens can condense the light to improve the brightness, and always being designed in arc-shaped and made by transparent material to enhance the condensation and transmittance. A plurality of light-emitting diodes 16 is installed on one or both ends of the heat conductible cavity 12 to be the light source. Please refer to FIG. 3, wherein the adhesion of the light-emitting diode 16 and the heat conductible cavity 12 can further utilize a high heat conductible material, such as tin grease or silver glue, to improve the heat dissipation and achieve the effect of high brightness and high heat dissipation.

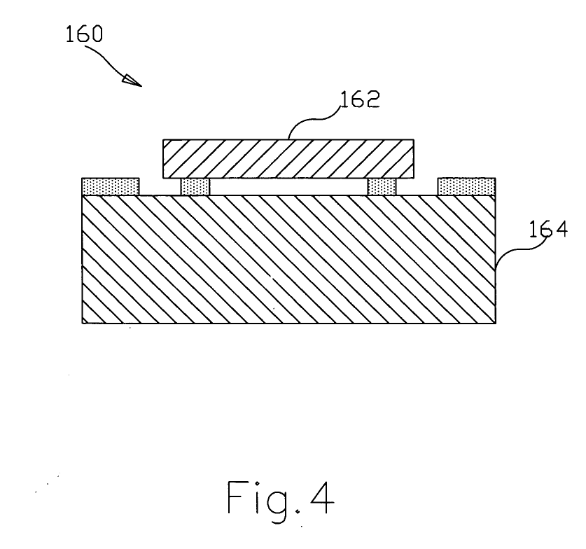

The light-emitting diode 16 can be the flip-chip light-emitting diode 160 shown in FIG. 4. The flip-chip light-emitting diode 160 includes a light-emitting diode chip 162 and a base 164, and the light-emitting diode 162 is mounted on the base 164 with a flip-chip way. The base 164 has a function of supplying power, whose material can be ceramics as AlN, BeO, or Al₂O₃, or isolative silicon material. The materials with high heat conductivity and the coefficient of expansion similar to the light-emitting diode chip 162 are all suitable. The base 164 is made with a high heat conductivity material, so the heat resistance is small and the power efficiency can be improved.

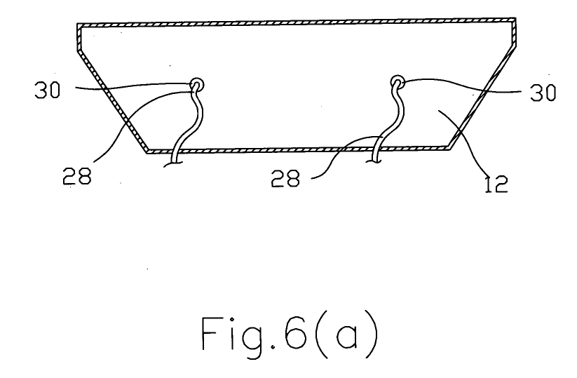

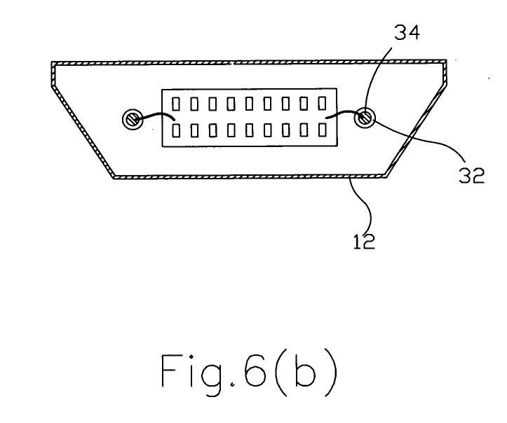

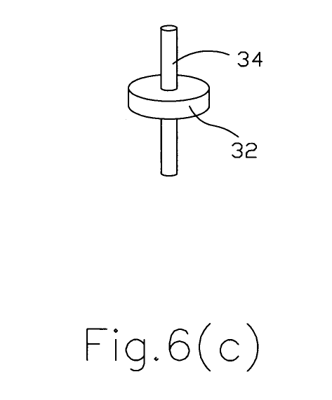

In addition, on the base of the flip-chip light-emitting diode, the power supply method is isolating the cavity to prevent getting an electric shock, and is explained with two followed embodiments. As shown in FIG. 6 (a), the external power line 28 is welded on the base of the flip-chip light-emitting diode via a cavity hole 30, and the power line 28 is wrapped with plastic to isolate to the cavity 12. Or as shown in FIG. 6 (b) and its partially enlarged graph in FIG. 6(c), a copper pillar 34 whose outer edge covered with an isolative bakelite 32 is adhered on the cavity 12, and the copper pillar 34 is used for conducting the power. Such kinds of conduction ways are too numerous to enumerate.

The flip-chip light-emitting diode 160 uses the light-emitting diode chips whose size are smaller than that of the packaged surface-mounted light-emitting diode. So the flip chip light-emitting diode can be arranged in high-density matrix, and the brightness can be improved without increasing the driving current of the light-emitting diodes. In addition, the requirement of the optical system is slacker. The present invention uses a plurality of light-emitting diode chips with big size to compose a single flip-chip light-emitting diode.

The light-emitting diode used in the present invention can be any color of light-emitting diodes, such as red light, white light, blue light, violet light, ultraviolet light, green light and so on.

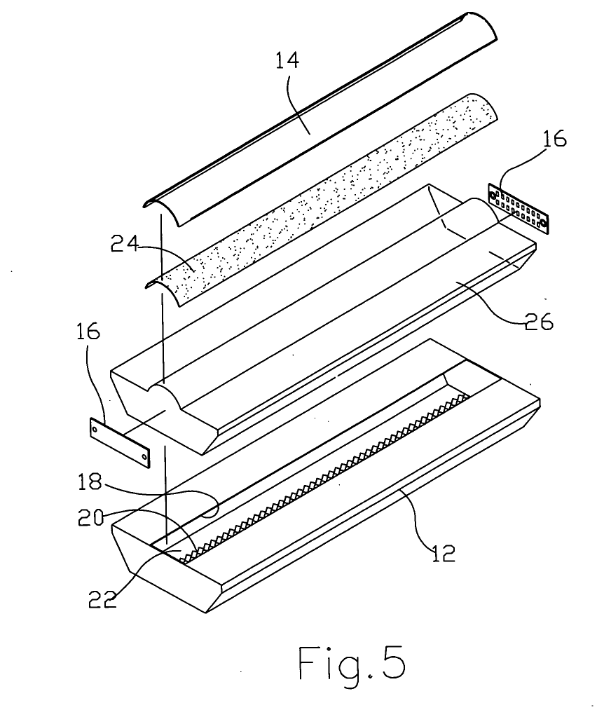

Please refer to FIG. 5, which is a structural diagram of another embodiment according to the present invention. For improving the efficiency of the claimed light-emitting diode lamp 10, except forming the reflective pattern 20, a reflective film (not shown) can be further equipped at the inner periphery of the heat conductible cavity 12 to improve the refractive efficiency. If the white light is desired, a layer of fluorescent powder 24 can be coated on the inner surface of the transparent cover 14 or stuffed in the chamber 22. Furthermore, the chamber 22 can be further stuffed with epoxy resin 26 to enhance the light.

In contrast to the prior art, the present invention using the material of high heat conductivity to be the cavity 12 can solve the conventional problem of worse heat dissipation. The light-emitting diode lamp 10 with high heat dissipation uses a plurality of light-emitting diodes 16 to be the light source. By means of the reflective pattern 20 under the lamp 12 and the reflective film in the cavity can enhance the uniformity of the light. The fluorescent powder 24 coated on the inner surface of the transparent cover 14 or stuffed in the chamber 22 can reinforce the light energy to be the white light. Then the rectangular opening 18 and the transparent cover 14 on the lamp 12 can condense the light to improve the brightness. Since the high efficient light-emitting diodes will produce much thermal energy while radiating, the present invention directly adheres the base of the flip-chip light-emitting diode and the cavity to conduct heat, and uses material with high heat conductivity, such as metal and ceramics, to be the cavity to dissipate heat rapidly. In addition, the present invention uses materials of metal, ceramics or semiconductor that can improve the crack situation of the plastic material after irradiated by the violet light or the ultraviolet light.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A light-emitting diode lamp with high heat dissipation, comprising:
a heat conductible cavity, on which equipped a rectangular opening, and a reflective pattern is formed under said heat conductible cavity corresponding to said opening;
a transparent cover, equipped on said rectangular opening, forming a chamber with said heat conductible cavity; and
at least one flip-chip light-emitting diode equipped on at least an end of said heat conductible cavity.

2. The light-emitting diode lamp of claim 1, wherein said flip-chip light-emitting diode further comprises a base and a plurality of light-emitting diode chips located on said base, and said light-emitting diode chips are formed on said base with flip-chip mode.

3. The light-emitting diode lamp of claim 2, wherein said light-emitting diode chips are arranged on said base with high-density matrix.

4. The light-emitting diode lamp of claim 2, wherein material of said base can be selected from a group composed of AlN, BeO, Al₂O₃ or Si.

5. The light-emitting diode lamp of claim 2, wherein said base further has function of static electricity protection.

6. The light-emitting diode lamp of claim 1, wherein said transparent cover is a condensing lens.

7. The light-emitting diode lamp of claim 1, wherein material of said heat conductible cavity is metal.

8. The light-emitting diode lamp of claim 1, wherein material of said heat conductible cavity is aluminum.

9. The light-emitting diode lamp of claim 1, wherein material of said heat conductible cavity is ceramic.

10. The light-emitting diode lamp of claim 1, wherein material of said heat conductible cavity is glass.

11. The light-emitting diode lamp of claim 1, wherein said light-emitting diode is a GaN light-emitting diode, and its light color is selected from blue light, violet light and ultraviolet light.

12. The light-emitting diode lamp of claim 1, wherein said light-emitting diode is a SiC light-emitting diode, and its light color is selected from blue light, violet light and ultraviolet light.

13. The light-emitting diode lamp of claim 1, wherein inner surface of said transparent cover can be further coated a layer of fluorescent powder.

14. The light-emitting diode lamp of claim 1, wherein inner periphery of said heat conductible cavity is equipped a reflective film.

15. The light-emitting diode lamp of claim 1, wherein said chamber is further stuffed with epoxy resin.

16. The light-emitting diode lamp of claim 1, wherein said chamber is further stuffed with fluorescent powder.

17. The light-emitting diode lamp of claim 1, wherein said reflective pattern under said heat conductible cavity is selected from a group composed of circular dot pattern, rectangular fillister pattern, trapezoid fillister pattern, slanting V-shaped continuous fillister pattern, V-shaped continuous fillister pattern and V-shaped intermittent fillister pattern.
